(19) United States
(12) Patent Application Publication
(10) Pub. No.: US 2010/0180272 A1
(43) Pub. Date: Jul. 15, 2010

(54) System For Enabling Virtual Services On A Business And A Consumer Device

(76) Inventors: Kevin Kettler, Austin, TX (US); Yuang-Chang Lo, Austin, TX (US); Shree A. Dandekar, Round Rock, TX (US)

Correspondence Address: HAMILTON & TERRILE, LLP, P.O. BOX 203518, AUSTIN, TX, 78720, US

(21) Appl. No.: 12/354,446

(22) Filed: Jan. 15, 2009

(51) Int. Cl. G06F 9/445; G06F 9/44; G06Q 30/00; G06Q 50/00

(52) U.S. Cl. 717/171; 717/174; 705/26

(57) ABSTRACT

A system for facilitating sale of a virtualized information handling system. The virtualized information handling system may be a consumer electronics type information handling system or a small business type information handling system. In operation the system offers a virtualization enabled information handling system at a point of sale. The offer can include an offer for an integrated (i.e., built-in) Productivity virtual machine as well as an integrated web browser. During the sale of the information handling system, the customer is provided with an opportunity to purchase additional virtual machines as part of an up-sell offer. If the customer opts not to purchase additional virtual machines, the customer can decide to purchase one or more of the proffered additional virtual machines at a later point. Each purchased virtual machine is uniquely linked to the customer.

### BACKGROUND OF THE INVENTION

1. Field of the Invention

The present invention relates to information handling systems and more particularly to a system for enabling virtual services on a business and consumer device.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Consumer electronics devices continue to mature to include consumer electronics type information handling systems. Consumer electronics type information handling systems enable content migration from a media information handling system to a living room as well as enabling televisions for broadband. One example of such a consumer electronics type information handling system includes a direct memory access (DMA) functionality using software such as the Microsoft extender technology software. Such a system provides no control over a software architecture to enable future services and provides no manufacturer differentiation.

Other issues relating to consumer electronics type information handling systems include limited adoption due to high set up costs and customer awareness. Often known solutions lack flexibility in terms of controlling software ad hardware distribution. Often known solutions do not offer personalization.

Attempting to address these issues via known information handling system platforms can also present challenges. For example, known information handling system platforms generally use well-defined development evolution based upon standard architectures. Also within known information handling system platforms, extensibility for added features is usually enabled using add in network interface controllers and controllers within predefined expansion slots such as PCIe slots. Other expansion may be accomplished via embedded controller for storage and multimedia playback devices. Such platforms have often include well defined end user models for Internet access, email and office type applications as well as the inability to provide a customer with a secure environment to plug in certain desired services or applications.

One such solution is providing virtualization enabled consumer electronics devices. However, offering virtualization enabled consumer electronics devices can include a plurality of challenges for the virtual machine provider. For example, as consumer electronics type information handling systems can have a relatively high set-up costs and relatively low customer awareness. Additionally, known virtual machine platforms lack flexibility in terms of controlling software and hardware distribution. Additionally, known virtual machine platforms do not offer personalization.

Accordingly, it would be desirable to provide an easily manageable and expandable array of consumer electronics based functions to consumers with limited or no information technology (IT) capabilities.

### SUMMARY OF THE INVENTION

In accordance with the present invention, a system for facilitating sale of a virtualized information handling system is set forth. The virtualized information handling system may be a consumer electronics type information handling system or a small business type information handling system. More specifically, in operation the system offers a virtualization enabled information handling system at a point of sale. The offer can include an offer for an integrated (i.e., built-in) Productivity virtual machine as well as an integrated web browser. During the sale of the information handling system, the customer is provided with an opportunity to purchase additional virtual machines as part of an up-sell offer. If the customer opts not to purchase additional virtual machines, the customer can decide to purchase one or more of the proffered additional virtual machines at a later point. Each purchased virtual machine is uniquely linked to the customer.

In certain embodiments, the service provider of the virtual machine embeds a unique key within the virtual machine that helps to unlock the subscription service for which the customer paid. The system takes advantage of logical partitioning of hardware and isolation technology offered by virtualization to provide enhanced security of premium content. Unlike traditional information handling systems, a virtual appliance executing on an information handling system is not an open platform. Accordingly, a virtual appliance type information handling system will likely be the platform of choice for studios and independent software vendors (ISVs) to deliver high valued content. A virtual appliance type platform is also a more secure mechanism for delivery of bundled appliances (e.g. DVD player, backup service, etc.).

When a customer accesses the virtual host of the virtual machine, the virtual machine communicates with a backend service provider server and authenticates the service the customer purchased to activate the virtual machine. The service provider can thus enforce various policies to force periodic measurement of executables (to ensure no alteration of the executables) and to ensure that the virtual machine is kept up to date. Should the customer terminates the service, the virtual machine can be remotely revoked. In case a customer loses a purchased virtual machine, the customer can communicate with the virtual machine provider and request a duplicate virtual machine with the same service enabled. The virtual machine provider can work with a server provider backend to re-provision the new virtual machine for the customer. The virtual machine provider can then rebuild the virtual machine memory device (e.g., a virtual machine USB stick) and ship the replacement virtual machine to the customer.

In an alternate embodiment the virtual machine provider can provide a web interface that allows the customer to re-image the purchased virtual machine to a blank memory device such as a USB key. If the customer's virtual machine is stolen and the thief attempts to use the virtual machine on a virtualization enabled host, the virtualization enabled host will request the credentials of the customer for authentication. More specifically, in certain embodiments, a security algorithm is setup within the virtual machine that detects a different host and requests user credentials. Alternately, in certain embodiments, a security algorithm is built-in to the host itself. When the host detects a new virtual machine, the host requests user credentials before allowing execution of the virtual machine.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1 shows a block diagram of a online store which includes a system for providing virtual machines.

FIG. 2 shows a block diagram of the operation of the system for providing virtual machines.

FIG. 3 shows a system block diagram of an information handling system.

FIG. 4 shows a system block diagram of a consumer electronics type information handling system infrastructure architecture.

FIG. 5 shows a flow chart of the operation of a consumer electronics type information handling system infrastructure architecture.

FIG. 6 shows a flow chart of the operation of a consumer electronics type information handling system infrastructure architecture.

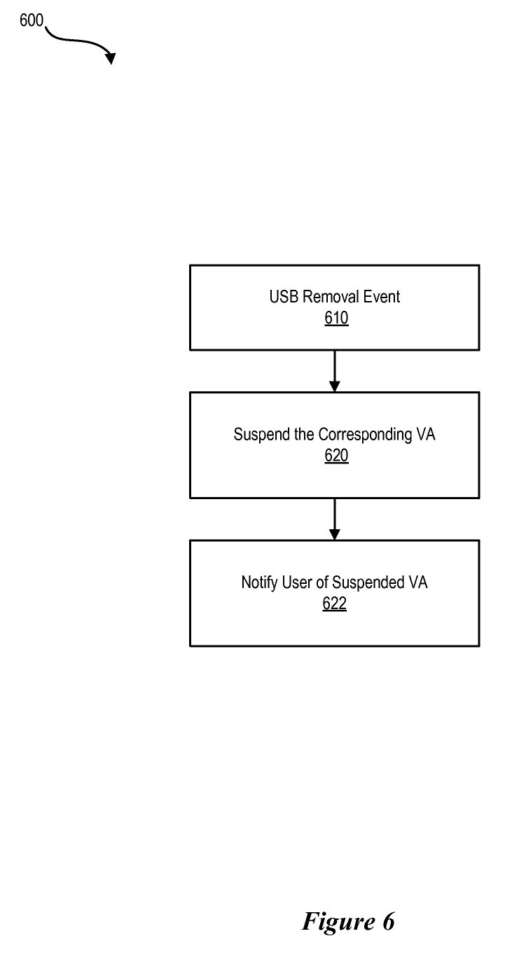

FIG. 7 shows a conceptual perspective view of a panel of a consumer electronics type information handling system.

FIG. 8 shows a block diagram a consumer electronics type information handling system architecture environment.

### DETAILED DESCRIPTION

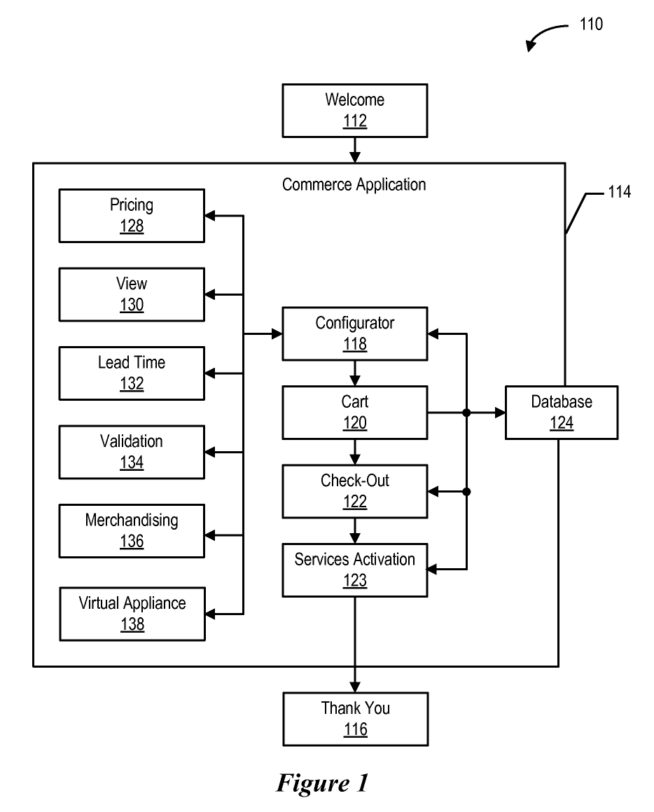

Referring to FIG. 1, a block diagram of a online store which includes a system for providing virtual machines is shown

Referring to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122 and services activation module 123. The configurator 118 includes a pricing module 128, a view module 130, a lead time warning module 132, a validation (or compatibility) warning module 134, a merchandising module 136 and a virtual appliance module 138. The various modules of the configurator 118 are driven by data from the database 124, and thus the configurator 118, shopping cart 120, checkout module 122 and services activation module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the services activation module 123 presents a services activation page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, a customer is transferred to a services activation page in which the customer is provided an opportunity to activate various services such as internet service or content services such as music services. After completion of the services activation module 123, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and services activation module 123 are each part of the commerce application 114 and interact with the database 124. For example, with the shopping cart 120, additional merchandising information associated with a particular system which has been configured and placed in the shopping cart by an on-line store customer can be provided.

Also for example, various services may be provided for order by the customer by the services activation module 123 based upon the type of system ordered as well as components that are included within the system ordered. Additionally, by providing the services activation module within the commerce application 114, the customer continues the experience a similar customer experience and the system provider is able to use the information from the database 124 and to maintain control over the customer contact. By maintaining control over the customer contact the system provider is able to determine what services are activated and to maintain accurate and up to date records of the service activation.

The virtual appliance module 138 enables the online store to facilitate sale of a virtualized information handling system. The virtualized information handling system may be a consumer electronics type information handling system or a small business type information handling system. More specifically, in operation the system (e.g., via the configurator 118) offers a virtualization enabled information handling system at a point of sale. The offer can include an offer for an integrated (i.e., built-in) Productivity virtual machine as well as an integrated web browser. During the sale of the information handling system, the customer is provided with an opportunity to purchase additional virtual machines as part of an up-sell offer. If the customer opts not to purchase additional virtual machines, the customer can decide to purchase one or more of the proffered additional virtual machines at a later point. Each purchased virtual machine is uniquely linked to the customer.

In certain embodiments, the service provider of the virtual machine embeds a unique key within the virtual machine that helps to unlock the subscription service for which the customer paid. The system takes advantage of logical partitioning of hardware and isolation technology offered by virtualization to provide enhanced security of premium content. Unlike traditional information handling systems, a virtual appliance executing on an information handling system is not an open platform. Accordingly, a virtual appliance type information handling system will likely be the platform of choice for studios and independent software vendors (ISVs) to deliver high valued content. A virtual appliance type platform is also a more secure mechanism for delivery of bundled appliances (e.g. DVD player, backup service, etc.).

When a customer accesses the virtual host of the virtual machine, the virtual machine communicates with a backend service provider server and authenticates the service the customer purchased to activate the virtual machine. The service provider can thus enforce various policies to force periodic measurement of executables (to ensure no alteration of the executables) and to ensure that the virtual machine is kept up to date. Should the customer terminates the service, the virtual machine can be remotely revoked. In case a customer loses a purchased virtual machine, the customer can communicate with the virtual machine provider and request a duplicate virtual machine with the same service enabled. The virtual machine provider can work with a server provider backend to re-provision the new virtual machine for the customer. The virtual machine provider can then rebuild the virtual machine memory device (e.g., a virtual machine USB stick) and ship the replacement virtual machine to the customer.

In an alternate embodiment the virtual machine provider can provide a web interface that allows the customer to re-image the purchased virtual machine to a blank memory device such as a USB key. If the customer's virtual machine is stolen and the thief attempts to use the virtual machine on a virtualization enabled host, the virtualization enabled host will request the credentials of the customer for authentication. More specifically, in certain embodiments, a security algorithm is setup within the virtual machine that detects a different host and requests user credentials. Alternately, in certain embodiments, a security algorithm is built-in to the host itself. When the host detects a new virtual machine, the host requests user credentials before allowing execution of the virtual machine.

Such a system for providing virtual machines may provide a plurality of different types of virtual machines. For example, the virtual machines can include a basic productivity type virtual machine. Such a basic productivity type virtual machine offers a customer with basic productivity type functionality (e.g., word processor, spread sheet, presentation and email client type functionality) at a point of sale. The basic productivity type functionality allows the virtual machine provider to upsell functionality such as enhanced browser capabilities, an ability to use personal email (e.g., a gmail or Yahoo type email account)

Additionally, the virtual machines can include a gaming type virtual machine. The gaming type virtual machine can include functionality for particular games as well as offering community based gaming. The gaming type virtual machines can further be specialized to casual type gaming virtual machines as well as extreme (i.e., hardcore) type gaming virtual machines. In certain embodiments, the extreme type gaming virtual machines might include those games with particular hardware requirements (e.g., certain video processing requirements). The gaming type virtual machine allows the virtual machine provider to upsell functionality such as providing hardware enhancements as well as particular gaming peripherals. The gaming type virtual machine offers can also include advertisements that are geared towards a particular demographic that may be found to correspond to the demographic that purchases gaming systems.

Additionally, the virtual machines can include online store type virtual machines. Online store type virtual machines can be further specialized for particular subscription services or for particular download services as well as for particular stores.

Additionally, the virtual machines can include digital content delivery type virtual machines. The digital content delivery type virtual machines can be further specialized for certain content providers such as Blockbuster, Netflix, Movielink, iTunes content providers. Digital content delivery type virtual machines provide an opportunity for a virtual machine provider to partner with a particular content provider.

Additionally, the virtual machines can include healthcare type virtual machines. The healthcare type virtual machines can be further specialized to include healthcare management virtual machines, disease management virtual machines, diet and fitness virtual machines, personal health record virtual machines, implant monitoring virtual machines. The healthcare type virtual machines provide an opportunity for a virtual machine provider to partner with and sell servers and services to healthcare providers.

Additionally, the virtual machines can include education type virtual machines. The education type virtual machines can be further specialized to include distance learning type virtual machines to facilitate access to university distant learning programs, customized learning and lecture virtual machines, and online student community virtual machines to facilitate students communicating such as would be the case for a particular class project. The education type virtual machines provide an opportunity for a virtual machine provider to upsell peripherals such as web cams for interactive sessions. The education type virtual machine provides an opportunity for a virtual machine provider to partner with particular search engine providers (e.g., the Google search engine) to provide customized searches for thesis related material and other course work related material

Additionally, the virtual machines can include home management type virtual machines such as home automation virtual machines and home maintenance virtual machines. The home management type virtual machines can be further specialized to include subscription service for downloading home design, automotive and gardening projects, as well as for communicating (e.g., via telephone or computer chat) with experts on custom projects. The home management type virtual machines provide an opportunity for a virtual machine provider to partner with and provide customized solutions or advertisements for suppliers such as Home Depot, Lowes, AutoZone etc.

Additionally, the virtual machines can include community forum type virtual machines. The community forum type virtual machines may be customized for particular community forums. The community forum type virtual machines provide an opportunity for a virtual machine provider to partner with and present advertisements that are directed to particular demographics based upon the type of community forum.

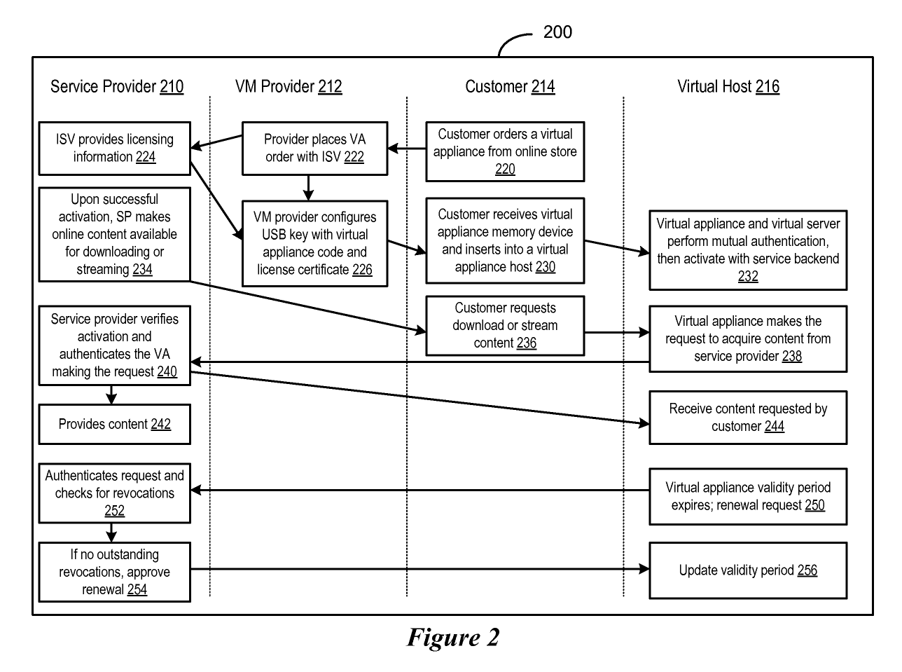

Referring to FIG. 2, a block diagram of the operation of the system 200 for providing virtual machines is shown. More specifically, the system for providing virtual machines provides for the purchase, activation, content access and renewal of virtual machines. The system for providing virtual machines includes a service provider portion 210, a virtual machine provider portion 212, a customer portion 214 and a virtual server portion 216.

More specifically, the system 200 starts operation by when a customer orders a virtual appliance from the online store 100 at step 220. Upon receipt of the order, the virtual machine supplier places a virtual appliance order with an independent software vendor (ISV) at step 222. Next, the ISV provides licensing information for the virtual appliance to the virtual machine provider at step 224. Next, the VP provider configures a virtual appliance memory device with the appropriate virtual appliance code as well as the corresponding license certificate at step 226. Next, the virtual machine provider delivers the virtual appliance to the customer. Upon receipt of the virtual appliance, the customer inserts the virtual appliance memory device into a virtual appliance host at step 230. The virtual appliance and the virtual appliance host then perform a mutual authentication to activate the service backend at step 232.

Upon successful activation, the service provider allows access to online content available for downloading or streaming at step 234. Next, when a customer requests download or stream content at step 236, the virtual appliance makes the request to acquire content from the service provider at step 238. Next, the service provider verifies activation and authenticates the virtual appliance that is making the request for access at step 240 and at step 242 provides the content to the customer. The requested content is received by the customer at step 244.

At some later time, if the virtual appliance validity period expires, as indicated at step 250, then the virtual appliance again communicates with the service provider to request authentication. The service provider authenticates the request and checks for any revocations of rights at step 252. If there are no outstanding revocations, then the service provider approves the renewal request at step 254. The virtual appliance then updates the validity period at step 256.

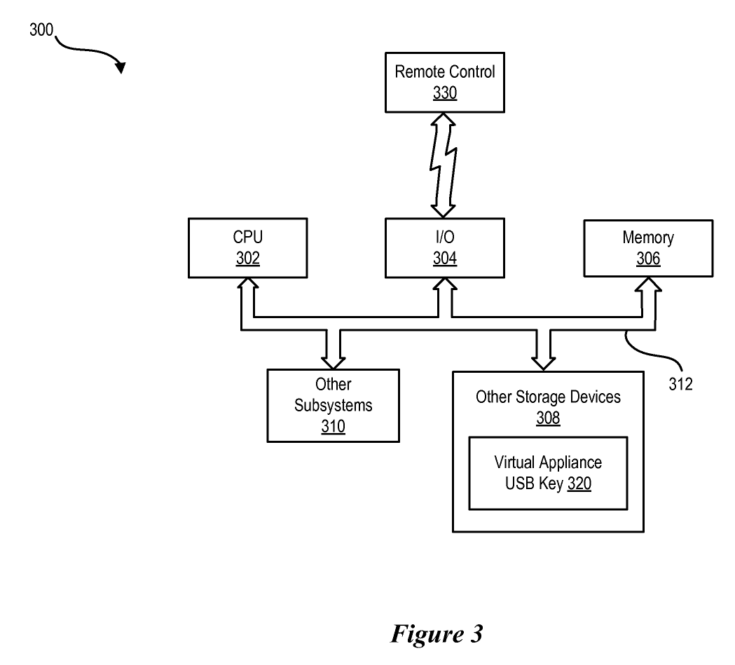

Referring briefly to FIG. 3, a system block diagram of an information handling system 300 is shown. The information handling system 300 includes a processor 302, input/output (I/O) devices 304, such as a display, a keyboard, a mouse, and associated controllers (each of which may be coupled to remotely to the information handling system 300), a memory 306 including volatile memory such as random access memory (RAM) and non-volatile memory such as a hard disk and drive, and other storage devices 308, such as an optical disk and drive and other memory devices, and various other subsystems 310, all interconnected via one or more buses 312. One example of another storage device 308 is a virtual appliance memory device such as a virtual appliance USB key 320. The I/O devices 304 can also include a remote control 330.

The virtual appliance USB key 320 can include one or a plurality of virtual appliances. Each virtual appliance is a self-contained virtual machine that implements a consumer solution (including an operating system (OS), and application and a default configuration). Examples of self-contained virtual machines can include a productivity module and browser, a media server/content delivery module, a home finance/online banking module, a gaming module, a personal networking module, a home automation and security module, and a home design and maintenance module. Because the virtual machines are self-contained and isolated using virtualization technology, each solution can be preconfigured and ready to use, without a customer having to install and configure the solution. Additionally, the virtual machines provide a stable platform which have no variability when moved from one user or system to another user or system.

Each of the virtual appliances is installed on the information handling system 300 via a respective virtual appliance USB key 320 (e.g., a personalization pod). Using a virtual appliance USB key 320 not only simplifies an initial installation, but also subsequent need to move the virtual machine if the capacity of the information handling system is exceeded. FIG. 2 shows the architecture diagram of the consumer electronics type information handling system 300.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

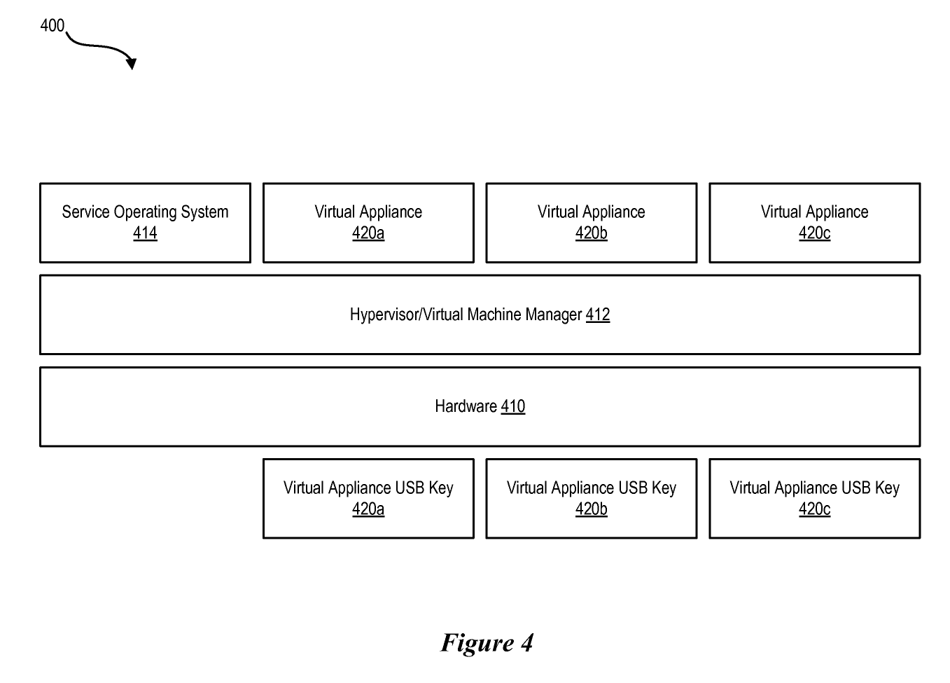

Referring to FIG. 4, a system block diagram of a consumer electronics type information handling system infrastructure architecture 400 is shown. More specifically, consumer electronics type information handling system hardware 410 executes a virtual machine manager application 412 (which may be e.g., a hypervisor). The consumer electronics type information handling system infrastructure architecture 400 also includes a service operation system 414 that is executed by the hardware 410.

One or more virtual appliance USB keys 320a, 320b, 320c may be coupled to the hardware 410. Each of the USB keys 220 allow a self contained virtual appliance 420 to be installed on the server 410. In certain embodiments, a digital certificate of authenticity (COA) is included with each virtual appliance 420. The COA is checked by the virtual hardware 410 before the appliance is installed onto the system 400.

A data structure with computing resource requirements is included with each virtual appliance on the USB key. These include CPU requirements, memory requirements, storage requirements, and network bandwidth requirements. Before a virtual appliance is installed, the virtual machine manager 412 ensures that it has enough capacity to host the appliance. The virtual machine manager 412 also contains a resource meter (which may be located on a panel of the information handling system) to represent current resource capacity and remaining resource capacity to simplify capacity planning. The virtual machine manager 412 can also maintain a database of all virtual machines that have been coupled to the device. In this way if a virtual machine is removed and then reinserted, the certification process can be expedited. Additionally, in certain embodiments, the system may have a more limited set of virtual machines to which the system is authorized. In this case, the virtual machine manager 412 can maintain information regarding the more limited set of virtual machines.

Because the personalization pods are self contained and isolated using virtualization technology, each solution can be preconfigured and ready to use, without a customer having to install and configure the solution. The personalization pods are installed onto the hardware via physical memory devices, such as USB keys, which not only simplify the initial installation, but also any subsequent move of the virtual machine such as if the capacity of the hardware is exceeded or if a virtual machine is moved from one device to another.

The virtual machine manager 412 is configured to allow only certified appliances to plug in to the device. Any time a consumer plugs in a non-certified appliance, the virtual machine manager will prompt the user to use a compatible version, or direct the user to a particular website (e.g., a particular universal resource locator (URL)) where the consumer can purchase or certify particular appliances or applications. In certain embodiments, the authentication and certification may be via an asymmetric encryption such s a Deffie-Hellman type encryption, also referred to an asymmetric encryption because it uses two keys instead of a single key. In this case, the public key would be used by the service provider and the secret key would be stored securely on the virtual machine or the virtual machine manager.

In certain embodiment, the hardware can include support for high definition (e.g., Blu-ray type) memory devices. The virtual machine manager 412 can thus enable playback of the high definition memory devices on the system.

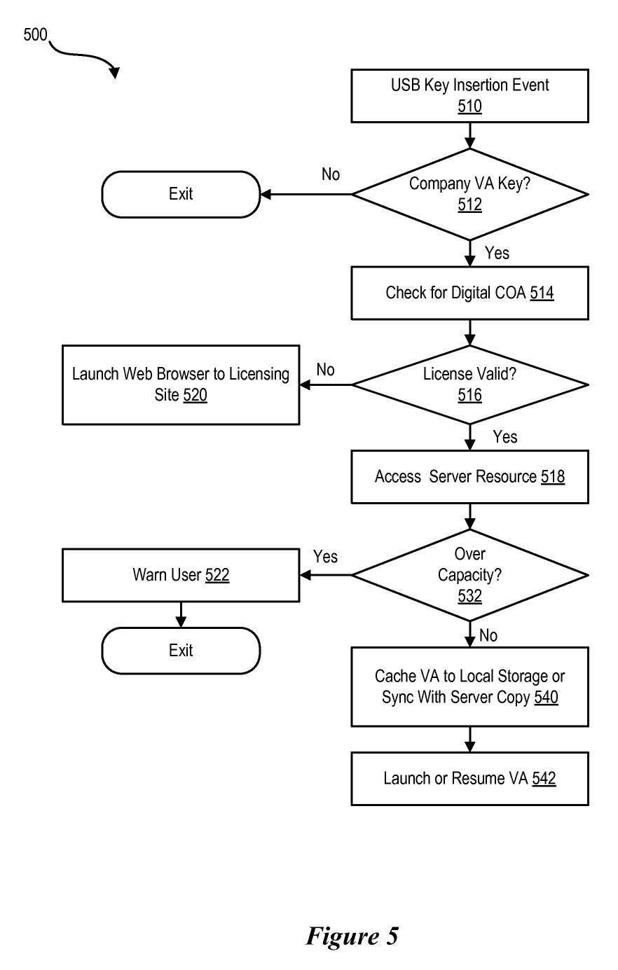

Referring to FIG. 5, a flow chart of the operation of a virtual appliance installation module 500 is shown. More specifically, when the virtual machine manager 412 detects a USB key insertion event at step 510, the virtual machine manager 412 determines whether the USB key is an authorized virtual appliance (VA) key (e.g., does the VA key correspond to a particular application) at step 512. If the key is not an authorized key, then the virtual appliance installation operation exits. If the key is an authorized key, then the virtual machine manager 412 analyzes the digital certificate of authenticity at step 514 and determines whether the virtual appliance includes a valid license at step 516. If the license is not valid, then the virtual appliance installation operation launches a web browser to access a virtual appliance licensing set at step 520.

If the license is valid, then the virtual appliance installation operation accesses the resources of the hardware at step 518. The virtual appliance installation operation then determines whether the hardware 410 is over capacity at step 532 based upon the available resources of the hardware 410 as well as the resources needed by the virtual appliance. If the hardware 410 is over capacity then the virtual appliance installation operation warns the user at step 534. If the resource of the hardware 410 is exceeded (e.g., as determined by step 532), the user is warned by a front panel indicator of this condition. The user may proceed with a number of options. The user can ignore the warning and leave the USB key in the system, in which case the system performance may degrade. Alternately, the user may remove the USB key from the system and insert the key into another system with more system resource capacity.

If the hardware 410 is not over capacity then the virtual appliance installation operation caches the virtual appliance to local storage or synchronizes the virtual appliance with a server copy at step 540. Next, the virtual appliance installation operation launches or resumes operation of the virtual appliance at step 542.

Referring to FIG. 5, a flow chart of the operation of a virtual appliance removal module 500 is shown. More specifically, when the virtual machine manager 212 detects a USB key removal event at step 510, the virtual machine manager 212 suspends execution of the virtual appliance which corresponds to the removed key at step 520 and generates a notification of the suspended virtual appliance at step 522. The front panel of the information handling system 100 also indicates the removal of the key.

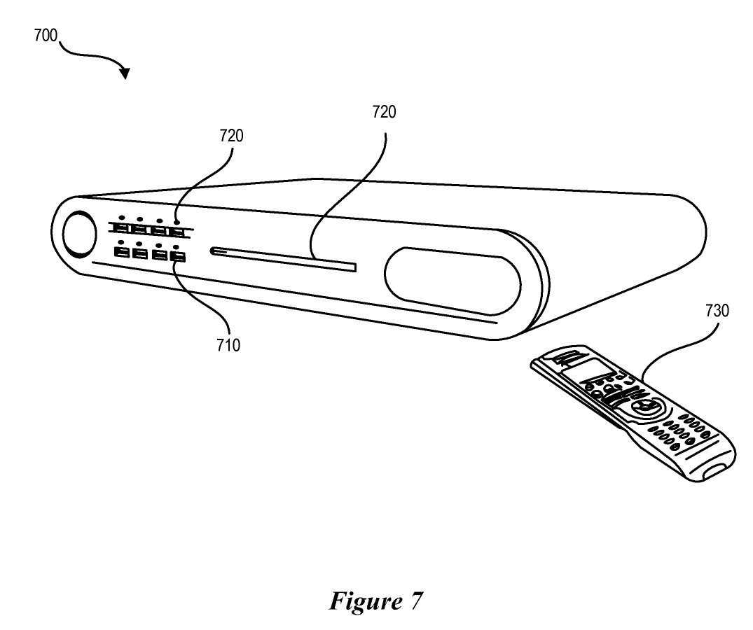

Referring to FIG. 7, a conceptual perspective view of a consumer electronics type information handling system is shown. More specifically, the consumer electronics type information handling system 700 includes a plurality of USB connections 710. Each USB connection includes a corresponding connection indication 720. The USB connection indication 720 can include an indicia (e.g., a color indication) of whether a virtual appliance is installed and executing on the consumer electronics type information handling system 300. The consumer electronics type information handling system 700 also includes a slot 730 into which additional media (such as e.g., a DVD or CD-ROM) may be inserted. The consumer electronics type information handling system 700 also includes a provision for communicating (e.g., an infrared receiver located on the front panel of the system with the remote control device 330 or other types of I/O devices.

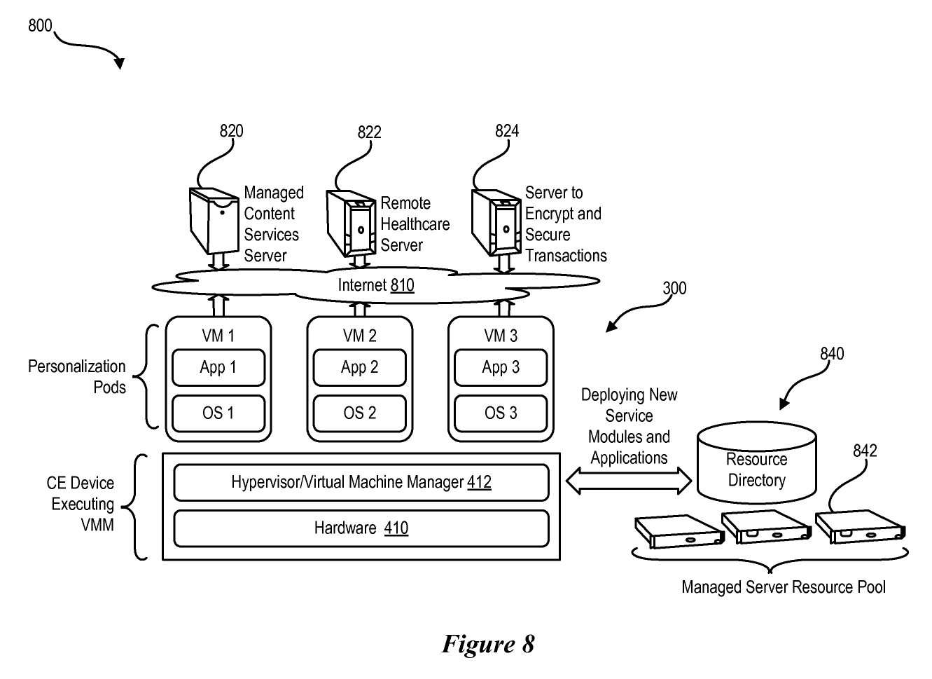

FIG. 8 shows a block diagram a consumer electronics type information handling system architecture environment 800. More specifically, the information handling system 100 includes a plurality of application specific virtual machines (VM1, VM2, and VM3), which are loaded via respective virtual appliance memory devices. Each application specific virtual machine includes a corresponding operating system (OS1, OS2, and OS3) as well as a corresponding application (App1, App2, and App3). The operating systems and applications execute on the hardware 410 under the control of the virtual machine manager 412. The virtual machines can access the Internet 810, either directly or via the hardware 410 of the system 100.

Each application may be directed to a particular consumer type application. For example, one application (e.g., App1) interacts with a managed content services server 820 via the Internet 810. Examples of manage content services include music types of services (such as download services or satellite radio services), video types of services (such as download services or video access services). Another application (e.g., App2) interacts with a remote healthcare server 822 via the Internet 810. The remote healthcare server enables a user to interact with hospitals or other types of health care services. The virtual machine includes any encryption information or patient information to facilitate the interaction with the healthcare server 822. Another application (e.g., App3) interacts with a banking server 824 via the Internet 810. The banking server enables a user to interact with various banks to perform various online banking transactions. The virtual machine includes any encryption information or customer information to facilitate the interaction with the banking server 822.

The consumer electronics type information handling system architecture environment 800 also includes a resource directory 840 having an associated managed server resource pool 842. The resource directory 840 is accessed by the system 100 when a virtual machine is coupled to the system to validate the virtual machine. The resource directory 840 can also provide service or update information to the system for each certified virtual machine.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the virtual appliance memory device 120 may function as a license and resource management token and not necessarily as a storage device for the virtual appliance.

Also for example, the virtual machine manager may include a unique user interface that executes on the hypervisor and display the current services that the customer can access. The user interface can also include notifications and messages to the user for different events and exceptions in a user friendly format.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for delivering pre-packaged software solutions to a consumer electronics type information handling system comprising:
configuring a virtual appliance according to user input, the configuring including customizing the virtual appliance based upon user selections;
providing a virtual appliance memory device, the virtual appliance memory device comprising the virtual appliance stored on the virtual appliance memory device, the virtual appliance comprising an application;
enabling installation of the virtual appliance onto a virtual machine host via the virtual appliance memory device; and,
enabling hosting of the application via the virtual appliance.

2. The method of claim 1 wherein:
the virtual appliance memory device comprises a virtual appliance universal serial bus (USB) key.

3. The method of claim 1 wherein:
the virtual machine host uses embedded virtualization technology to host the application as a virtual appliance.

4. The method of claim 1 wherein:
the application comprises at least one of a productivity and browser application, a media server/content delivery application, a home finance/online banking application, a gaming application, a personal networking application, a home automation and security application, and a home design and maintenance application.

5. The method of claim 1 further comprising:
enabling re-imaging of the virtual appliance on a virtual appliance memory device should an original copy of the application need to be replaced.

6. The method of claim 1 further comprising:
automatically deploying updates to the application via a supplier backend server.

7. An apparatus for delivering pre-packaged software solutions to a consumer electronics type information handling system comprising:
means for configuring a virtual appliance according to user input, the configuring including customizing the virtual appliance based upon user selections;
a virtual appliance memory device, the virtual appliance memory device comprising the virtual appliance stored on the virtual appliance memory device, the virtual appliance comprising an application;
means for enabling installation of the virtual appliance onto a virtual machine host via the virtual appliance memory device; and,
means for enabling hosting of the application via the virtual appliance.

8. The apparatus of claim 7 wherein:
the virtual appliance memory device comprises a virtual appliance universal serial bus (USB) key.

9. The apparatus of claim 7 wherein:
the virtual machine host uses embedded virtualization technology to host the application as a virtual appliance.

10. The apparatus of claim 7 wherein:
the application comprises at least one of a productivity and browser application, a media server/content delivery application, a home finance/online banking application, a gaming application, a personal networking application, a home automation and security application, and a home design and maintenance application.

11. The apparatus of claim 7 further comprising:
enabling re-imaging of the virtual appliance on a virtual appliance memory device should an original copy of the application need to be replaced.

12. The apparatus of claim 7 further comprising:
means for automatically deploying updates to the application via a supplier backend server.
